(19) United States
(12) Patent Application Publication
(10) Pub. No.: US 2019/0177204 A1
(43) Pub. Date: Jun. 13, 2019

(54) METHOD FOR MANUFACTURING OPTICAL FIBER PREFORM AND METHOD FOR MANUFACTURING OPTICAL FIBER

(71) Applicant: FURUKAWA ELECTRIC CO., LTD., Tokyo (JP)

(72) Inventors: Shinichi ARAI, Tokyo (JP); Takeshi YAGI, Tokyo (JP); Shigeto MATSUMOTO, Tokyo (JP)

(73) Assignee: FURUKAWA ELECTRIC CO., LTD., Tokyo (JP)

(21) Appl. No.: 16/089,182

(22) PCT Filed: Mar. 28, 2017
(86) PCT No.: PCT/JP2017/012673

§ 371 Date: Sep. 27, 2018

(30) Foreign Application Priority Data
Mar. 30, 2016 (JP) 2016-069320

(51) Int. Cl. C03B 37/018

(52) U.S. Cl. CPC C03B 37/01853; C03B 37/02

(57) ABSTRACT

A manufacturing method for an optical fiber preform includes forming a porous material made of fine silica glass particles surrounding a plurality of glass rods; and sintering the porous material, wherein the forming the porous material includes forming the porous material such that two or more of the plurality of glass rods protrude from the porous material, and the sintering includes supporting end portions of protruding sides of the two or more protruding glass rods collectively with a support jig, and performing the sintering. With this, a reduction in manufacturing yield is suppressed.

### TECHNICAL FIELD

The present invention relates to a method of manufacturing an optical fiber preform and a method of manufacturing an optical fiber using the same.

### BACKGROUND ART

Glass rods formed of silica glass are primarily used in manufacturing of optical fibers in the field of optical communication and optics. In the related art, such glass rods (optical fiber preforms) are manufactured, for example, by forming a porous material of silica glass using an outside vapor deposition (OVD) method or a powder molding method so as to surround a glass rod for forming a core portion that is produced by a vapor-phase axial deposition (VAD) method, producing a porous preform, and further heating and sintering the porous preform.

In the case of manufacturing what is known as a single-core type optical fiber that includes a single core portion in the optical fiber, one glass rod is used for forming the core portion, and the porous preform has a structure in which one glass rod for forming the core portion protrudes from the vicinity of the center axis of the porous material. When sintering the porous preform, the porous preform is held in a sintering furnace by gripping this single glass rod for forming the core portion, and sintering is performed.

In contrast, in order to cope with the recent increase in transmission capacity in optical fiber communication, multi core fibers having a plurality of core portions in the cross section of the optical fiber have been contemplated. As methods of manufacturing the optical fiber preform for a multi core fiber, a perforation method in which a plurality of holes are made in a glass rod, and a glass rod for forming a core portion is inserted into each of the holes, or alternatively, a stack-and-draw method in which glass rods for forming core portions are bundled and drawn, are generally used. However, in the case of the perforation method, as steps for preparing the glass rod and further forming a plurality of holes in the glass rod are involved, there are problems in that it is difficult to manufacture a large optical fiber preform, and the cost increases. Also, in the case of the stack-and-draw method, in addition to the difficulty of manufacturing large optical fiber preforms, there are constraints on the cost and structure, such as difficulty in increasing the positional accuracy of the core.

In contrast to this, a method in which the previously mentioned porous preform is produced and sintered is widely used as a manufacturing method of optical fibers, and since it is possible to manufacture large optical fiber preforms, even in cases of manufacturing multi core fibers, it is advantageous from a cost standpoint.

For example, as schematically illustrated in FIG. 15A, cases are considered for manufacturing a multi core fiber 3 in which a core portion 1 is constituted by a core portion 1a located at the center and six core portions 1b are arranged surrounding it so as to form a regular hexagon, and cladding portions 2 are formed on the outer periphery of these core portions 1. It should be noted that the region surrounded by the broken line in the multi core fiber 3 is a region formed by a glass rod for forming a core portion, as described later.

FIG. 15B schematically illustrates a porous preform 4 for manufacturing the multi core fiber 3. The porous preform 4 has a structure in which a porous material 6 formed from fine glass particles is deposited around seven glass rods 5 for forming the core portion, and the seven glass rods 5 protrude from the porous material 6. Here, the glass rods 5 have a structure in which a cladding portion forming portion for forming a part (the region surrounded by the outer edges of the core portions 1 and the broken lines in FIG. 15A) of the cladding portion 2 is formed around the core portion forming portion for forming the core portion 1.

In the case of sintering this porous preform 4, the porous preform 4 is held in the sintering furnace by gripping the end of the protruding side of the glass rod 5a located at the center of the protruding glass rods 5 with the grasping tool 7, and performing sintering while rotating the porous preform 4 around its axis (See Patent Document 1).

### CITATION LIST

### Patent Literature

Patent Document 1: Japanese Patent Publication No. 5740065

### SUMMARY OF INVENTION

### Technical Problem

However, in the case illustrated in FIG. 15B, a large stress is partially applied to the porous material 6 due to the weight of the glass rods 5b that are not gripped, cracks are generated in the porous material 6, and there is a risk of the porous material 6 breaking. As a result, there is a problem that the manufacturing yield of the optical fiber preform may be reduced in some cases.

The present invention has been made in view of the above, and has an object of providing a method of manufacturing an optical fiber preform in which the reduction in manufacturing yield is suppressed, and a method of manufacturing optical fibers thereof.

### Solution to Problem

In order to solve the above mentioned problems and achieve the object, a manufacturing method for an optical fiber preform, according to an aspect of the present invention includes a step of forming a porous material made of fine glass particles surrounding a plurality of glass rods; and a step of sintering the porous material, wherein: the step of forming the porous material includes forming the porous material such that two or more of the plurality of glass rods protrude from the porous material, and the step of sintering includes supporting end portions of protruding sides of the two or more protruding glass rods collectively with a support jig, and performing the sintering.

In the manufacturing method for the optical fiber preform, according to an aspect of the present invention, the support jig is configured to allow the supported glass rods to move in a direction that approaches the center axis of the porous material.

In the manufacturing method for the optical fiber preform, according to an aspect of the present invention, the support jig is configured to allow the supported glass rods to be tilted in a direction that approaches the center axis of the porous material.

According to another aspect of the present invention, a manufacturing method for optical fiber includes drawing an optical fiber from an optical fiber preform manufactured by the manufacturing method according to an aspect of the present invention.

### Advantageous Effects of Invention

According to the present invention, it is possible to realize a method of manufacturing an optical fiber preform in which the reduction in manufacturing yield is suppressed and a method of manufacturing optical fibers.

### BRIEF DESCRIPTION OF DRAWINGS

FIG. 1A is a schematic diagram for explaining a first configuration example of a support jig used in a forming step of a porous material.

FIG. 1B is a schematic diagram for explaining the first configuration example of the support jig used in the forming step of the porous material.

FIG. 1C is a schematic diagram for explaining the first configuration example of the support jig used in the forming step of the porous material.

FIG. 2 is a schematic diagram for explaining the forming step of the porous material.

FIG. 3A is a schematic diagram for explaining a first configuration example of the support jig used in a sintering step of the porous material.

FIG. 3B is a schematic diagram for explaining the first configuration example of the support jig used in the sintering step of the porous material.

FIG. 4 is a schematic diagram for explaining a second configuration example of the support jig used in the forming step of the porous material.

FIG. 5A is a schematic diagram for explaining a structure of an end portion of the glass rod depicted in FIG. 4.

FIG. 5B is a schematic diagram for explaining the structure of the end portion of the glass rod depicted in FIG. 4.

FIG. 5C is a schematic diagram for explaining the structure of the end portion of the glass rod depicted in FIG. 4.

FIG. 5D is a schematic diagram for explaining the structure of the end portion of the glass rod depicted in FIG. 4.

FIG. 6 is a schematic diagram for explaining a third configuration example of the support jig used in the sintering step of the porous material.

FIG. 7A is a schematic diagram illustrating an example of a configuration of a support member of the support jig depicted in FIG. 6.

FIG. 7B is a schematic diagram illustrating an example of a configuration of the support member of the support jig depicted in FIG. 6.

FIG. 7C is a schematic diagram illustrating an example of a configuration of the support member of the support jig depicted in FIG. 6.

FIG. 7D is a schematic diagram illustrating an example of a configuration of the support member of the support jig depicted in FIG. 6.

FIG. 8 is a schematic diagram for explaining the movement of the glass rod in the sintering step.

FIG. 9A is a schematic diagram for explaining a fourth configuration example of the support jig used in the sintering step of the porous material.

FIG. 9B is a schematic diagram for explaining a fourth configuration example of the support jig used in the sintering step of the porous material.

FIG. 10A is a schematic diagram for explaining the structure of the end portion of the glass rod.

FIG. 10B is a schematic diagram for explaining the structure of the end portion of the glass rod.

FIG. 10C is a schematic diagram for explaining the structure of the end portion of the glass rod.

FIG. 10D is a schematic diagram for explaining the structure of the end portion of the glass rod.

FIG. 11 is a schematic diagram for explaining a fifth configuration example of the support jig used in the sintering step of the porous material.

FIG. 12 is a schematic diagram for explaining the tilt and bending of the glass rod in the sintering step.

FIG. 13 is a schematic diagram for explaining a sixth configuration example of the support jig used in the sintering step of the porous material.

FIG. 14 is a schematic diagram for explaining a forming step of a porous material by a powder molding method.

FIG. 15A is a schematic diagram for explaining a multi core fiber.

FIG. 15B is a schematic diagram for explaining a porous preform for forming a multi core fiber.

FIG. 16 is a schematic diagram illustrating a configuration of a multi core fiber.

### DESCRIPTION OF EMBODIMENTS

Hereinafter, embodiments of a method for manufacturing an optical fiber preform and a method of manufacturing optical fiber according to the present invention will be described in detail with reference to the drawings. It should be noted that the present invention is not limited by these embodiments. In addition, in each drawing, the same or corresponding elements are denoted by the same reference signs, as appropriate.

The method for manufacturing an optical fiber preform according to the present invention includes a step of forming a porous material made of fine glass particles surrounding a plurality of glass rods; and a step of sintering the porous material, wherein the step of forming the porous material includes forming the porous material such that two or more of the plurality of glass rods protrude from the porous material, and the step of sintering includes supporting end portions of protruding sides of the two or more protruding glass rods collectively with a support jig, and performing the sintering. In this way, as the weight of the porous preform can be supported by two or more glass rods, generation of cracks or the like in the porous material is suppressed or prevented, whereby the reduction in the manufacturing yield of the optical fiber preform is suppressed.

### Embodiment 1

Hereinafter, a forming step of a porous material and a sintering step of a porous material according to Embodiment 1 will be specifically described. In the forming step of the porous material, a plurality of glass rods are prepared, fine glass particles are deposited around these glass rods, and the porous material are formed. Glass rods manufactured by a VAD method can be utilized. In addition, the forming step of the porous material includes using an OVD method.

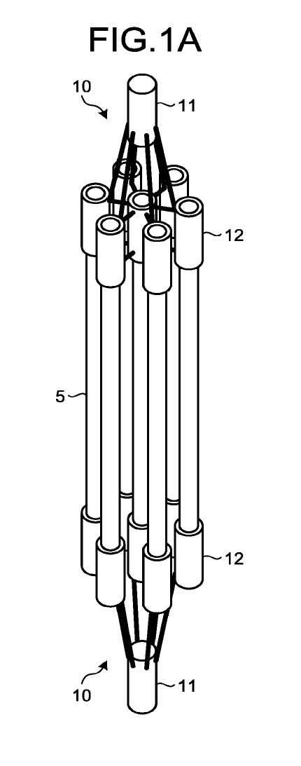

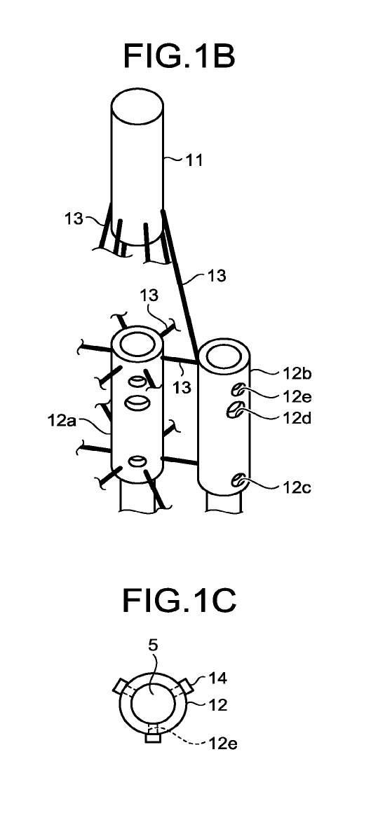

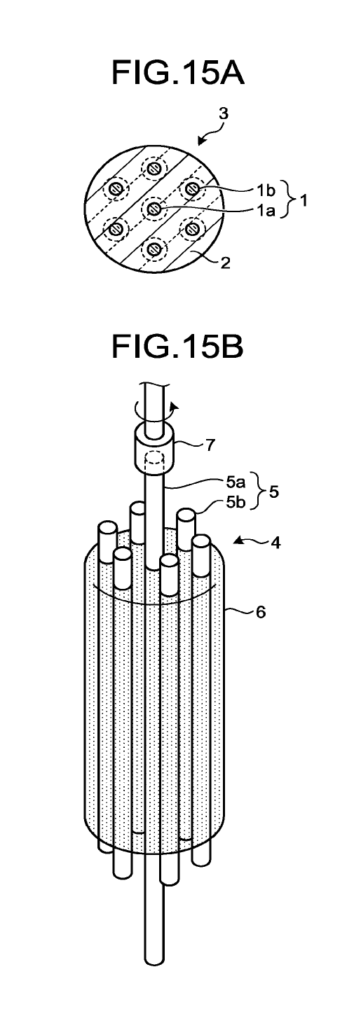

FIG. 1A, FIG. 1B, and FIG. 1C are schematic diagrams for explaining a first configuration example of a support jig used in the forming step of a porous material according to Embodiment 1. As illustrated in the overall view of FIG. 1A, a support jig 10 can support seven glass rods 5, and is used when manufacturing a multi core fiber 3 illustrated in FIG. 15A. The support jig 10 includes a rotational axis shaft 11, seven glass rod support pipes 12, and twelve connecting rods 13. These constituent elements are made of, for example, a metal material.

The rotational axis shaft 11 is a member that serves as an axis of rotation when the glass rods 5 are revolved in the forming step of the porous material by the OVD method. The glass rod support pipes 12 are members into which the glass rods 5 are inserted, and that support the glass rods 5. The glass rod support pipes 12 are arranged such that the glass rods 5 are to be arranged as glass rods in the porous preform to be produced. In Embodiment 1, among the seven glass rod support pipes 12, a glass rod support pipe 12a is arranged in the center, and the six glass rod support pipes 12b are arranged around this center to form a regular hexagon on the outer periphery. Hereinafter, in cases in which the glass rod support pipe 12a and the glass rod support pipes 12b arc not distinguished from each other, they will be referred to as glass rod support pipes 12.

As illustrated in an enlarged view of the primary part of FIG. 1B, six of the twelve connecting rods 13 are provided so as to connect the rotational axis shaft 11 and a corresponding one of the glass rod support pipes 12b. The remaining six of the twelve connecting rods 13 are provided so as to connect the glass rod support pipe 12a and a corresponding one of the glass rod supporting pipes 12b.

In addition, as illustrated in FIG. 1B, one rod hole position adjustment hole 12c1 and three rod fixing screw holes 12c, 12e are each formed in the glass rod support pipe 12. The three rod fixing screw holes 12c, 12e are arranged so as to form an angle of 120° with each other. Both ends of the glass rods 5 are inserted into the glass rod support pipes 12 with which each of the two support jigs 10 is provided, and fixed by screwing fixing screws 14 into the rod fixing screw holes 12c and 12e, whereby the glass rods 5 are supported by the support jigs 10. It should be noted that although FIG. 1C illustrates the rod fixing screw hole 12e, the rod fixing screw hole 12c is similarly arranged.

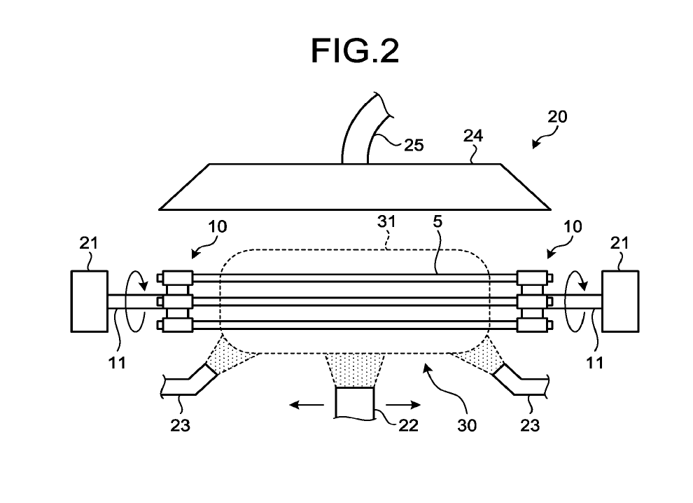

Next, as illustrated in FIG. 2, the rotational axis shaft 11 of the support jig 10 is gripped by a chuck 21 of an OVD device 20, and the glass rods 5 are revolved. Then, while rotating the glass rods 5, a glass source gas and combustion gases such as H₂ gas and O₂ gas are supplied to a main burner 22, which is a burner for synthesizing fine glass particles, combustion gases such as H₂ gas and O₂ gas are supplied to an end burner 23, and fine glass particles are deposited on the glass rods 5. SiCl₄ or the like can be used as the glass source gas, for example.

The main burner 22 synthesizes fine glass particles by flame hydrolysis of the glass source gas in the flame formed by the combustion gas. It should be noted that the main burner 22 moves forward and backward in an extending direction of the glass rods 5, and deposits fine glass particles uniformly in the extending direction of the glass rods 5 to form a porous material 31 made of silica glass. It should be noted that the end burner 23 is used to make the outer diameters of both ends of the porous material 31 substantially equal to the outer diameter at the center portion in the length direction of the porous material 31. The fine glass particles that are not deposited are discharged from an exhaust hood 24 via an exhaust pipe 25. In this way, the porous material 31 is formed, and the porous preform 30 in which the seven glass rods 5 protrude from the porous material 31 is formed.

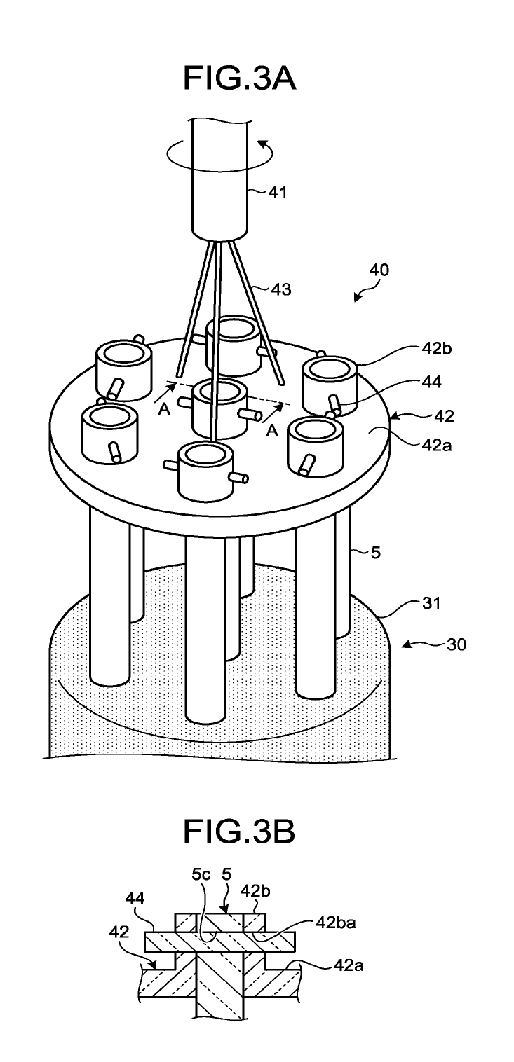

Next, the sintering step of the porous material 31 will be described. FIG. 3A and FIG. 3B are schematic diagrams for explaining a first configuration example of a support jig used in the sintering step of the porous material according to Embodiment 1. A support jig 40 is capable of supporting seven glass rods 5 protruding from the porous material 31 of the porous preform 30. As illustrated in FIG. 3A, the support jig 40 includes a rotational axis shaft 41, a support member 42, three connecting rods 43, and seven fixing pins 44. These constituent elements are formed of silica glass material.

The rotational axis shaft 41 is a member that serves as an axis of rotation when the porous preform 30 is rotated in the sintering step. The support member 42 has a configuration in which cylindrical support portions 42h are provided on a disc-shaped base portion 42a. The support portions 42b are disposed at positions corresponding to the arrangement of the glass rods 5. An end portion of each of the glass rods 5 is inserted into a corresponding one of the support portions 42b. It should be noted that, although both ends of each of the glass rods 5 protrude from the porous material 31 in the present embodiment, in cases where the porous preform is produced such that only one end portion of the glass rods 5 protrude from the porous material, the end portion on the protruding side of the glass rods 5 are inserted into the support portions.

The connecting rods 43 are provided so as to connect the rotational axis shaft 41 and the base portion 42a.

In addition, FIG. 3B is a cross-sectional view taken along the line A-A in FIG. 3A. Through-holes 42ba and 5c are formed in the support portion 42b and the glass rod 5, respectively. A fixing pin 44 is passed through the through-holes 42ba and 5c. In this way, the glass rods 5 are fixed to the support portion 42b. As a result, the seven glass rods 5 are collectively supported by the support jig 40. In this way, by supporting the seven glass rods 5 with the support jig 40, the porous preform 30 is held in the sintering furnace, and the porous material 31 is heated and sintered while being rotated around the axis. As a result, the porous material 31 is vitrified, and the porous preform 30 becomes an optical fiber preform.

It should be noted that in order to pass the fixing pin 44 through the through-holes 42ba and 5c, it is necessary that the glass rod 5 and the support portion 42b have a positional relationship such that the through-hole 42ba and the through-hole 5c communicate with each other. In order to realize this, when attaching the glass rod 5 to the support jig 10 depicted in FIG. 1A, attachment should be performed such that the through-hole 5c of the glass rod 5 and the rod hole position adjustment hole 12d of the glass rod support pipe 12 communicate with each other. At this time, by inserting a fixing bolt into the through-hole 5c and the rod hole position adjustment hole 12d and screwing a nut from a tip of the fixing bolt and fastening it to the glass rod support pipe 12, it is possible to ensure the positional relationship between the through-hole 5c and the rod hole position adjustment hole 12d. By setting the positional relationship between the rod hole position adjustment hole 12d of the glass rod support pipe 12 and the through-hole 42ba of the support portion 42b so as to correspond to each other, the positional relationship can be made such that the through-hole 42ba communicates with the through-hole 5c.

As explained above, in Embodiment 1, because the porous material 31 is heated and sintered while the porous preform 30 is held in the sintering furnace by supporting the end portions of the seven glass rods 5 with the support jig 40 that can collectively support the end portions of the glass rods 5, the total weight of the porous preform 30 is supported by the seven glass rods 5 and thus the stress applied between the porous material 31 and the glass rods 5 is reduced. As a result, generation of cracks and the like in the porous material 31 is prevented. In this way, reduction in the manufacturing yield is prevented.

### Embodiment 2

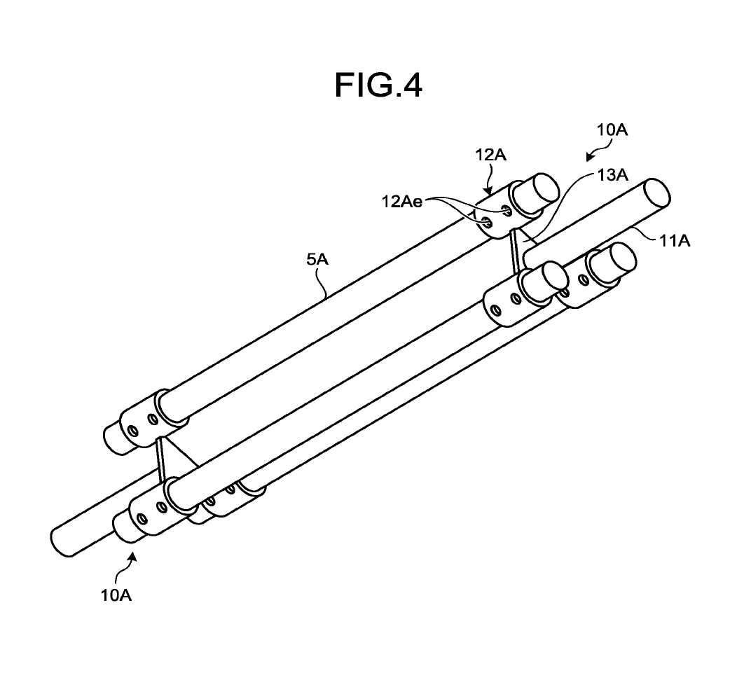

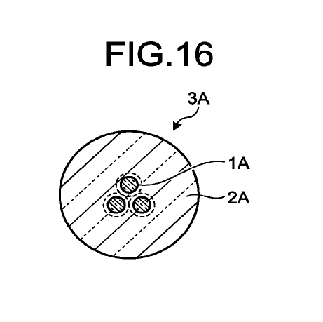

A forming step of a porous material and a sintering step of a porous material according to Embodiment 2 will be specifically described. FIG. 4 is a schematic diagram for explaining a second configuration example of a support jig used in the forming step of the porous material. A support jig 10A is capable of supporting three glass rods 5A produced by a VAD method, and is used when producing a multi core fiber 3A having three core portions 1A and a cladding portion 2A as depicted in FIG. 16. It should be noted that the glass rods 5 depicted in FIG. 1A and the glass rods 5A are substantially the same, but the differences therebetween will be described in detail later. The support jig 10A includes a rotational axis shaft 11A, three glass rod support pipes 12A, and one connecting plate 13A. These constituent elements are made of, for example, a metal material.

The rotational axis shaft 11A is a member that serves as an axis of rotation when the glass rods 5A are revolved in the forming step of the porous material by the OVD method. The glass rod support pipes 12A are members into which the glass rods 5A are inserted, and that support the glass rods 5A. The glass rod support pipes 12A are arranged such that the glass rods 5A are to be arranged as glass rods in the porous preform to be produced. In the second embodiment, the three glass rod support pipes 12A are arranged so as to form an equilateral triangle.

The connecting plate 13A has an equilateral triangular shape, has the glass rod support pipes 12A provided at corresponding vertexes, and has the rotational axis shaft 11A erected at the center thereof.

In addition, six rod fixing screw holes 12Ae are formed in each of the glass rod support pipe 12A. As to the six rod fixing screw holes 12Ae, three of the rod fixing screw holes 12Ae, which constitute one set, are arranged so as to form an angle of 120° with each other. Both ends of the glass rods 5A are inserted into the glass rod support pipes 12A with which each of the two support jigs 10A is provided, and fixed by screwing fixing screws into the rod fixing screw holes 12Ae, whereby the glass rods 5A are supported by the support jigs 10A.

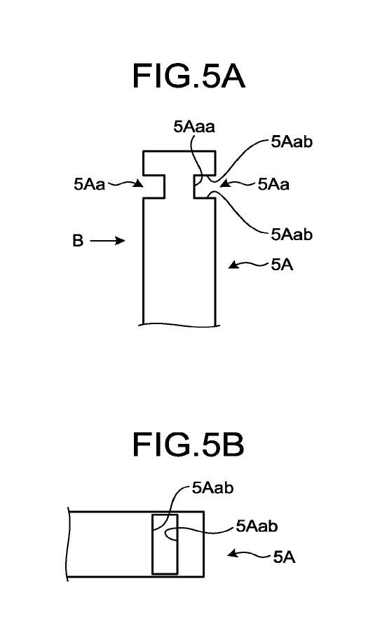

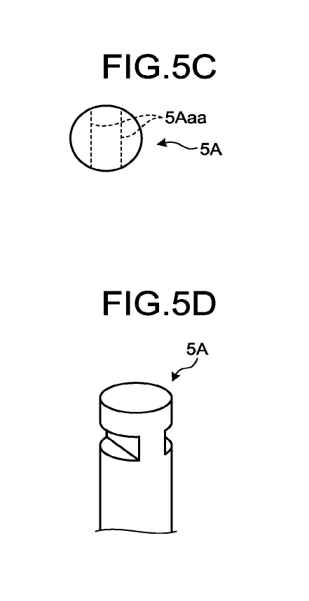

Here, FIG. 5A to FIG. 5D are schematic diagrams for explaining the structure of the end portion of the glass rods 5A. The differences between the glass rods 5 and the glass rods 5A will be described with reference to FIG. 5A to FIG. 5D. FIG. 5A, FIG. 5B, FIG. 5C, and FIG. 5D are a side view, an arrow B view, a top view, and a perspective view of the end portion of a glass rod 5A, respectively.

On the side surface of the end portion of the glass rods 5A, two recessed portions 5Aa are formed, each of which has a bottom surface 5Aaa and inner side surfaces 5Aab that arc parallel to each other. The bottom surfaces 5Aaa of the two recessed portions 5Aa are parallel to each other.

In the forming step of the porous mother body, a porous material is formed using the support jig 10A by the OVD method as in the first embodiment, and a porous preform is formed in which both ends of the three glass rods 5A protrude from the porous material.

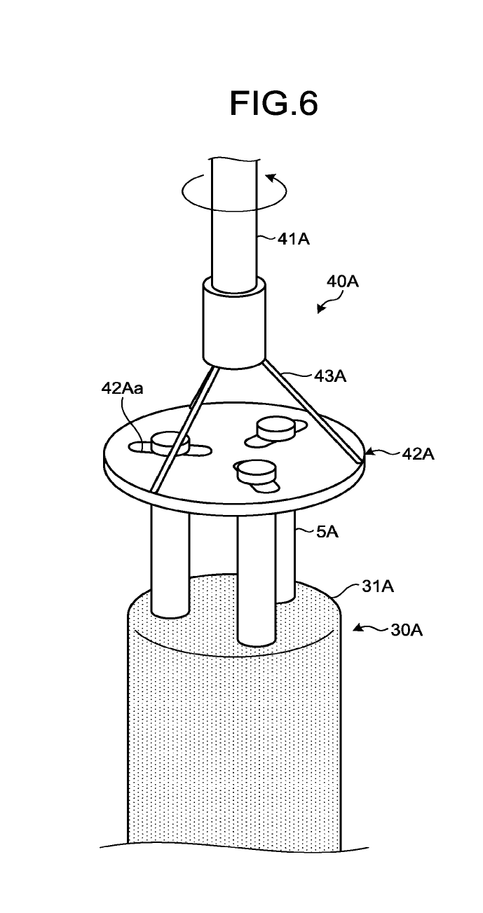

Next, the sintering step of the porous material will he described. FIG. 6 is a schematic diagram for explaining a third configuration example of a support jig used in the sintering step of the porous material according to Embodiment 2. A support jig 40A is capable of supporting the three glass rods 5A protruding from a porous material 31A of a porous preform 30A. The support jig 40A includes a rotational axis shaft 41A, a support member 42A, and three connecting rods 43A provided so as to connect the rotational axis shaft 41A and the support member 42A. These constituent elements are formed of silica glass material.

The rotational axis shaft 41A is a member that serves as an axis of rotation when the porous preform 30A is rotated in the sintering step. The support member 42A has a disc shape, and has a configuration in which three long holes 42Aa are provided. The long holes 42Aa are arranged at locations corresponding to the arrangement of the glass rods 5A, and extend radially from the center of the support member 42A. Each of the glass rods 5A is supported by the support member 42A by fitting the recessed portion 5Aa formed at the end portion of the glass rod 5A into each of the long holes 42Aa. As a result, the three glass rods 5A are collectively supported by the support jig 40A.

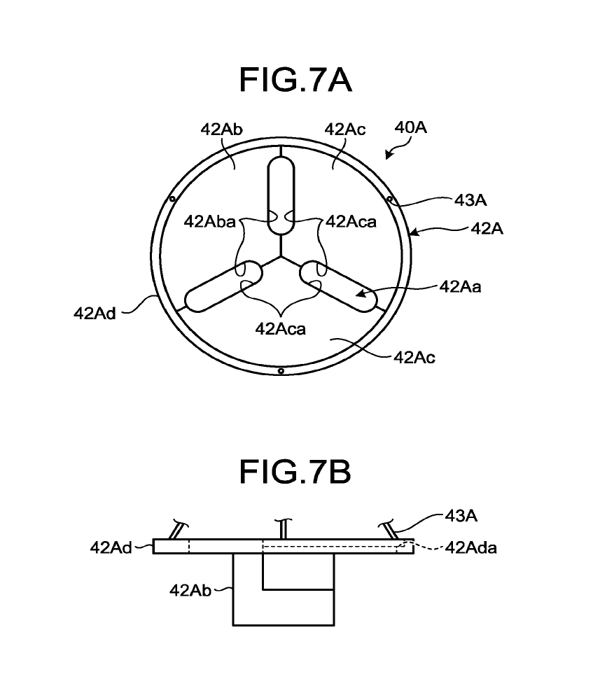

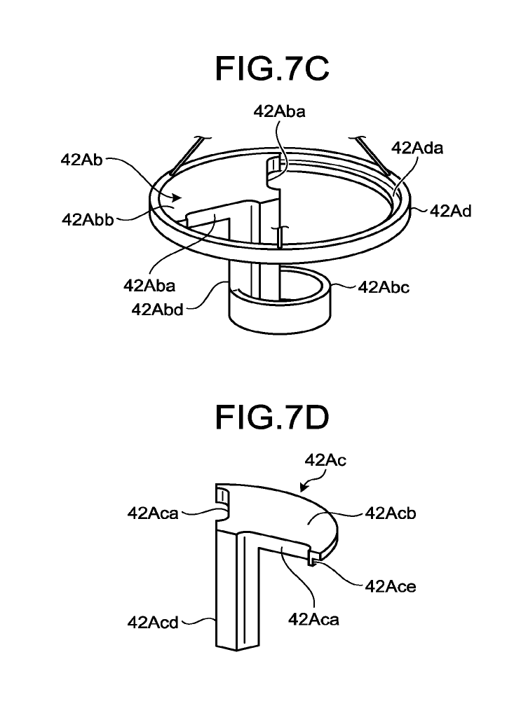

Incidentally, in order to fit the recessed portion 5Aa of each of the glass rods 5A into a corresponding one of the long holes 42Aa, the support jig 40A may have the following structure, for example. FIG. 7A to FIG. 7D are schematic diagrams illustrating an example of a configuration of the support member 42A of the support jig 40A. The support member 42A is constituted by connecting one member 42Ab, two members 42Ac, and one member 42Ad. FIG. 7A is a top view of the support member 42A, FIG. 7B and FIG. 7C arc a side view and a perspective view, respectively, of a state in which the member 42Ab and the member 42Ad are fitted together, and FIG. 7D is a perspective view of the member 42Ac.

The member 42Ad is a connecting ring member, and in addition to being provided with connecting rods 43A, also has a stepped portion 42Ada formed on its inner peripheral side for fitting the members 42Ab and 42Ac.

The member 42Ab includes a substantially fan-shaped plate portion 42Abb having a stepped portion (not illustrated in the drawings) fitted to the stepped portion 42Ada and a recessed portion 42Abc for forming the long hole 42Aa, a cylindrical portion 42Abc that houses a part of the member 42Ac, and a connecting portion 42Abd for connecting the plate portion 42Abb and the cylindrical portion 42Abc.

The member 42Ac includes a substantially fan-shaped plate portion 42Acb, formed on the outer periphery, having a stepped portion 42Ace fitted to the stepped portion 42Ada, and having a recessed portion 42Aca for forming the long hole 42Aa, and an extending portion 42Acd extending from the plate portion 42Acb.

The support member 42A is assembled by inserting each of the extending portions 42Acd of the two members 42Ac into the cylindrical portion 42Abc of the member 42Ab, connecting the member 42Ab and the two members 42Ac, and fitting the connected member to the member 42Ad. At this time, the recessed portions 42Aba of the member 42Ab and the recessed portions 42Aca of the member 42Ac are combined, and the recessed portions 42Aca of the two members 42Ac are combined, thereby to form the long holes 42Aa.

When connecting the member 42Ab and the two members 42Ac, by connecting them after fitting the recessed portion 5Aa of each of the glass rods 5A into the recessed portion 42Aba or the recessed portion 42Aca, the recessed portion 5Aa of each of the glass rods 5A can be fitted into a corresponding one of the long holes 42Aa.

By supporting the three glass rods 5A with the support jig 40A as described above, the porous preform 30A is held in the sintering furnace, and the porous material 31A is heated and sintered while being rotated around the axis. As a result, the porous material 31A is vitrified, and the porous preform 30A becomes an optical fiber preform.

In Embodiment 2, as in the case of Embodiment 1, because the total weight of the porous preform 30A is supported by the three glass rods 5A in the sintering step, the stress applied between the porous material 31A and the glass rods 5A is reduced. As a result, as in the case of Embodiment 1, reduction in the manufacturing yield is prevented.

Furthermore, even in cases where the glass rods 5A are not present in the center axis of the porous preform 30A, it is possible to suppress the application of unbalanced stress to the porous material, and to prevent the reduction in the manufacturing yield. Such an effect can also be obtained in Embodiments 3 to 6 in which a glass rod is not present in the center axis of the porous preform, which will be described below.

Incidentally, in the process of sintering the porous material 31A to form a glass body, the volume of the porous material 31A contracts. With this contraction, the porous material 31A exerts a stress on the three glass rods 5A that causes them to become closer to each other. In particular, the porous material 31A exerts a stress on the three glass rods 5A that causes them to become closer to the center of the axis of the porous material 31A.

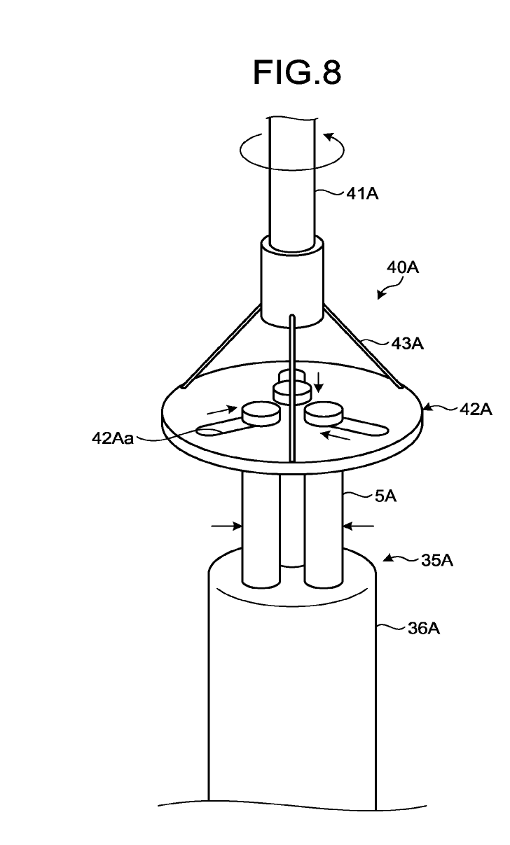

In the present Embodiment 2, each of the glass rods 5A is supported by the support member 42A by fitting the recessed portion 5Aa into a corresponding one of the long holes 42Aa. Accordingly, as illustrated in FIG. 8, in the process in which the porous material 31A contracts and becomes a glass body 36A of an optical fiber preform 35A, when stress is applied to the three glass rods 5A, each of the glass rods 5A is guided by a corresponding one of the long holes 42Aa, and moves closer to the center axis of the porous material 31. In this way, as the support jig 40A is configured to be able to support the glass rods 5A so as to allow the glass rods 5A to move in a direction that approaches the center axis of the porous material 31, and thus bending of each glass rod 5A is prevented.

It should be noted that unlike the support jig 40A, when a support jig that immobilizes the end portions of the respective glass rods is used, since each glass rod becomes closer to the center axis of the porous material 31A due to the contraction of the porous material, as the parts located in the glass body are closer to each other than the parts fixed by the support jig, each glass rod is bent.

### Embodiment 3

A forming step of a porous material and a sintering step of a porous material according to Embodiment 3 will be described. The forming step of the porous material according to the present Embodiment 3 is substantially the same as that of Embodiment 2, but the glass rod 5 of Embodiment 1 is used as the glass rod.

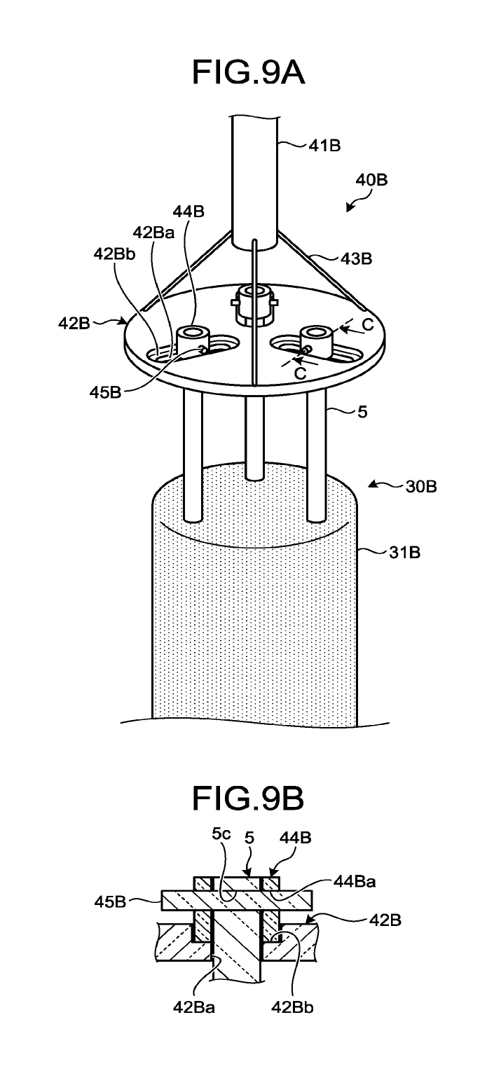

Next, the sintering step of the porous material will be described. FIG. 9A and FIG. 9B are schematic diagrams for explaining a fourth configuration example of a support jig used in the sintering step of the porous material to Embodiment 3. A support jig 40B is capable of supporting three glass rods 5 protruding from a porous material 31B of a porous preform 30B. The support jig 40B includes a rotational axis shaft 41B, a support member 42B, three connecting rods 43B provided so as to connect the rotational axis shaft 41B and the support member 42B, three fixing rings 44B, and three fixing pins 45B. These constituent elements are formed of silica glass material.

The rotational axis shaft 41B is a member that serves as an axis of rotation when the porous preform 30B is rotated in the sintering step. The support member 42B has a disc shape, and has a configuration in which three long holes 42Ba and guide grooves 42Bb provided at outer edges of the long holes 42Ba are provided. The long holes 42Ba are arranged at locations corresponding to the arrangement of the glass rods 5, and extend radially from the center of the support member 42B. Fixing rings 44B are fitted into corresponding ones of the guide groove 42Bb, and corresponding ones of the glass rods 5 are inserted thereinto.

In addition, FIG. 9B is a cross-sectional view taken along the line C-C in FIG. 9A. Through-holes 44Ba and 5c are formed in the fixing ring 44B and the glass rod 5, respectively. A fixing pin 4513 is passed through the through-holes 44Ba and 5c. In this way, the glass rods 5 are fixed to the fixing ring 44B and supported by the support member 42B. As a result, the three glass rods 5 are collectively supported by the support jig 40B. In this way, by supporting the three glass rods 5 with the support jig 40B, the porous preform 30B is held in the sintering furnace, and the porous material 31B is heated and sintered while being rotated around the axis. As a result, the porous material 31B is vitrified, and the porous preform 30B becomes an optical fiber preform.

In the present Embodiment 3, as in the case of Embodiments 1 and 2, because the total weight of the porous preform 30B is supported by the three glass rods 5 in the sintering step, the stress applied between the porous material 31B and the glass rods is reduced. As a result, as in the case of Embodiments 1 and 2, reduction in the manufacturing yield is prevented.

Further, in the present Embodiment 3, as in Embodiment 2, the support jig 40B is configured to be able to support the glass rods 5 to allow the glass rods 5 to move in a direction that approaches the center axis of the porous material 31B. Specifically, in the process in which the porous material 31B contracts and becomes a glass body, when stress is applied to the three glass rods 5, each of the glass rods 5 moves closer to the center axis of the porous material 31B as the fixing ring 44B fixed to a corresponding one of the glass rods 5 is guided by the guide grooves 42Bb. As a result, as in the case of Embodiment 2, bending of each of the glass rods 5 is prevented.

### Embodiment 4

A forming step of a porous mother body and a sintering step of a porous material according to Embodiment 4 will be specifically described. The forming step of the porous material according to the present Embodiment 4 is substantially the same as that of Embodiments 2 and 3, but a glass rod described below is used as the glass rod.

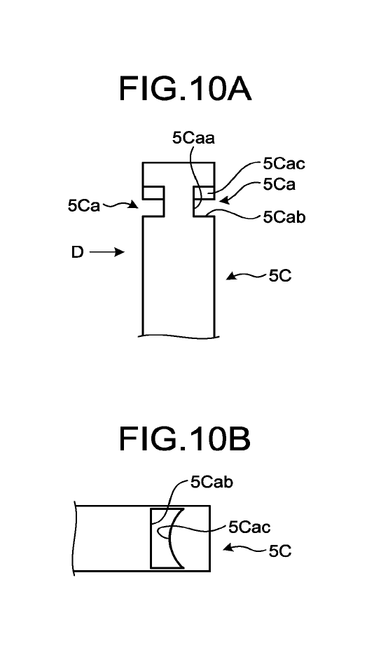

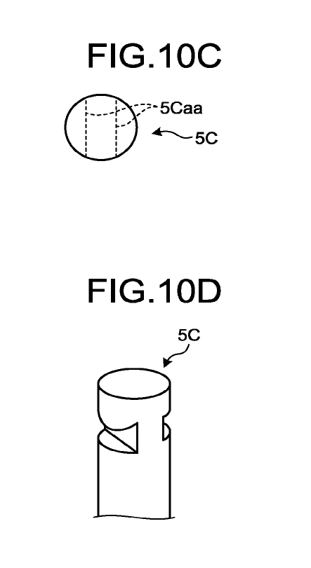

FIG. 10A to FIG. 10D are schematic diagrams for explaining the structure of the end portion of a glass rod 5C. FIG. 10A, FIG. 10B, FIG. 10C, and FIG. 10D are a side view, an arrow D view, a top view, and a perspective view of the end portion of the glass rod 5C, respectively.

On the side surface of the end portion of the glass rod 5C, two recessed portions 5Ca are formed, each of which has a bottom surface 5Caa, as well as a planar inner side surface 5Cab and an inner side surface 5Cac being a curved surface of a cylindrical shape, which are opposed with each other. The bottom surfaces 5Caa of the two recessed portions 5Ca are parallel to each other. In addition, the inner side surface 5Cac is formed closer to the end portion of the glass rod 5C than the inner side surface 5Cab.

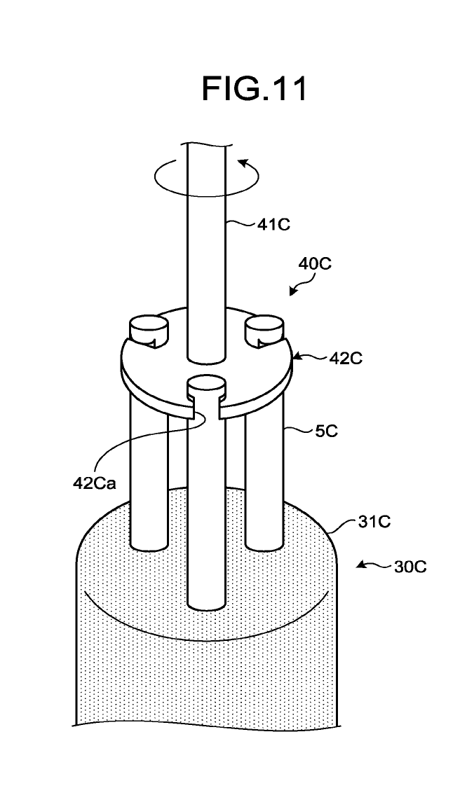

Next, the sintering step of the porous material will be described. FIG. 11 is a schematic diagram for explaining a fifth configuration example of a support jig used in the sintering step of the porous material. A support jig 40C is capable of supporting the three glass rods 5C protruding from a porous material 31C of a porous preform 30C. The support jig 40C includes a rotational axis shaft 41C and a disc-shaped support member 42C. These constituent elements are formed of silica glass material.

The rotational axis shaft 41C is erected at the center of the support member 42C, and is a member that serves as an axis of rotation when the porous preform 30C is rotated in the sintering step. The support member 42C has a configuration in which three notches 42Ca are provided on the outer edge. The notches 42Ca are provided at locations corresponding to the arrangement of the glass rods 5C. Each of the glass rods 5C is supported by the support member 42C by fitting the recessed portion 5Ca formed at the end portion of the glass rod 5C into a corresponding one of the notches 42Ca. As a result, the three glass rods 5C are collectively supported by the support jig 40C.

In this way, by supporting the three glass rods 5C with the support jig 40C, the porous preform 30C is held in the sintering furnace, and the porous material 31C is heated and sintered while being rotated around the axis. As a result, the porous material 31C is vitrified, and the porous preform 30C becomes an optical fiber preform.

In the present Embodiment 4, as in the case of Embodiments 1 to 3, because the total weight of the porous preform 30C is supported by the three glass rods 5C, the stress applied between the porous material 31C and the glass rods 5C is reduced. As a result, as in the case of Embodiments 1 to 3, reduction in the manufacturing yield is prevented.

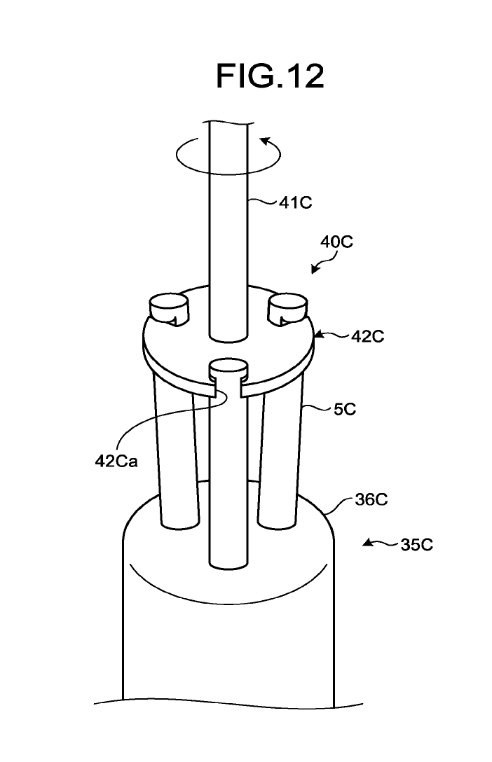

Incidentally, in the process of sintering the porous material 31C to form a glass body, along with the contraction thereof, a stress is exerted on the three glass rods 5C that causes them to become closer to the center axis of the porous material 31C. In this way, as illustrated in FIG. 12, in the process in which the porous material 31C contracts and becomes a glass body 36C of an optical fiber preform 35C, when stress is applied to the three glass rods 5C, each of the glass rods 5C is bent such that the distance between each other is closer in a part located within the glass body 36C than in a part fixed to the support jig 40C.

In the present Embodiment 4, although each of the glass rods 5C is supported by the support member 42C by fitting the recessed portion 5Ca into a corresponding one of the notches 42Ca, the inner side surface 5Cac being the curved surface is substantially in line contact with the upper surface of the support member 42C. When each of the glass rods 5C is bent as described above, the inner side surface 5Cac being the curved surface rolls while maintaining line contact with the upper surface of the support member 42C. That is, the glass rods 5C are configured to allow the glass rods 5C to be inclined with respect to the support jig 40C in a direction that approaches the center axis of the porous material 31C. Here, the inclination of the glass rods 5C means that the glass rods 5C is inclined with respect to the center axis of the porous material 31C. As a result, even in a case where each of the glass rods 5C bends, it is possible to prevent a stress that would damage the glass rods 5C from being applied between the support member 42C and the glass rods 5C. It should be noted that, in order to prevent a stress that would damage the glass rods 5C from being applied, it is preferable to set the distance between the inner side surface 5Cab and the inner side surface 5Cac such that, even in the case where the glass rod 5C bends, the inner side surface 5Cab of the recessed portion 5Ca does not contact the lower surface of the support member 42C.

### Embodiment 5

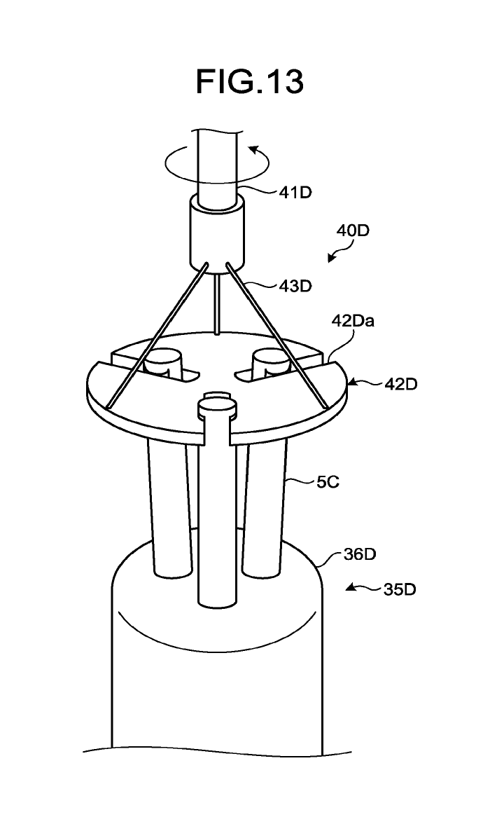

A forming step of a porous material and a sintering step of a porous material according to Embodiment 5 will be described. The forming step of the porous material according to the present Embodiment 5 is substantially the same as that of Embodiment 4. In contrast, the sintering step of the porous material includes using a support jig of the sixth configuration example illustrated in FIG. 13. A support jig 40D is capable of supporting the three glass rods 5C protruding from a porous material of a porous preform. The support jig 40D includes a rotational axis shaft 41D, a support member 42D, and three connecting rods 43D provided so as to connect the rotational axis shaft 41D and the support member 42D. These constituent elements are formed of silica glass material.

The rotational axis shaft 41D is a member that serves as an axis of rotation when the porous preform is rotated in the sintering step. The support member 42D has a disc-shape, and has a configuration in which three notches 42Da are provided on the outer edge. The notches 42Da are arranged at locations corresponding to the arrangement of the glass rods 5C, and extend toward the center of the support member 42D. Each of the glass rods 5C is supported by the support member 42D by fitting the recessed portion 5Ca formed at the end portion of the glass rod 5C into a corresponding one of the notches 42Da. As a result, the three glass rods 5C are collectively supported by the support jig 40D.

In this way, by supporting the three glass rods 5C with the support jig 40D as described above, the porous preform is held in the sintering furnace, and the porous material is heated and sintered while being rotated around the axis. As a result, the porous material is vitrified and becomes the glass body 36D as depicted in FIG. 13, and the porous preform becomes the optical fiber preform 35D.

In the present Embodiment 5, as in the case of Embodiments 1 to 4, because the total weight of the porous preform is supported by the three glass rods 5C, the stress applied between the porous material and the glass rods is reduced. As a result, as in the case of Embodiments 1 to 4, reduction in the manufacturing yield is prevented.

In addition, in the present Embodiment 5, as in Embodiments 2 and 3, because the notches 42Da extend toward the center of the support member 42D, the support jig 40D is configured to be able to support the glass rods 5C to allow the glass rods 5C to move in a direction that approaches the center axis of the porous material. Furthermore, the glass rods 5C are configured to allow the glass rods 5C to be inclined with respect to the support jig 40D in a direction that approaches the center axis of the porous material. As a result, in addition to suppressing bending of each of the glass rods 5C, it is possible to prevent a stress that would damage the glass rods 5C from being applied between the support member 42D and the glass rods 5C even in the case where each glass rod 5C bends.

### Embodiment 6

A forming step of a porous material according to Embodiment 6 and a sintering step of a porous material will be described. The forming step of the porous material according to Embodiment 6 includes using a powder molding method. In addition, a glass rod 5A is used as the glass rod.

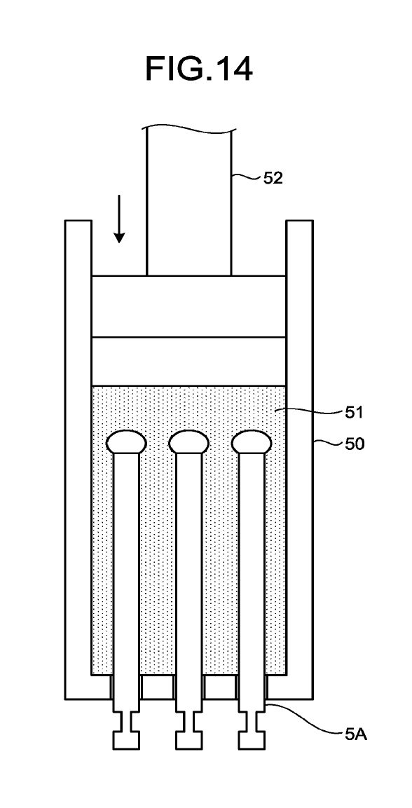

FIG. 14 is a schematic diagram for explaining a forming step of a porous material by a powder molding method. In the powder molding method, three glass rods 5A are gripped in a pressurizing mold 50, and granulated particles 51 of silica glass are inserted into the pressurizing mold 50 and pressure-formed by a pressurizing plunger 52 to form a porous material as a pressure-molded body. In this way, a porous preform in which three glass rods 5A protrude from the porous material is formed. It should be noted that, in the upper part of the drawing, the reason why the tips of the glass rods 5A are machined into spherical bodies having a diameter larger than an outer diameter of a part of the glass rods 5A that have a substantially constant outer diameter is to make the glass rods 5A less likely to fall out of the porous material in the subsequent sintering step.

The subsequent sintering step of the porous material can be performed using the same method as in Embodiment 2. In this way, as in the case of Embodiments 1 to 5, reduction in the manufacturing yield is prevented.

It should be noted that optical fiber can be manufactured by drawing an optical fiber from the optical fiber preform manufactured according to the above embodiments by a known method using a known fiber-drawing furnace.

### EXAMPLE 1

As Example 1 of the present invention, three porous preforms were produced according to the method of Embodiment 1 and sintered in accordance with the method of Embodiment 1 to produce three optical fiber preforms. Although the three optical fiber preforms had cracks on the upper part, no abnormalities such as cracks were observed in most of the other parts, and the three optical fiber preforms were favorable.

### Comparative Example 1

As Comparative Example 1, three porous preforms were produced according to the method of Embodiment 1. Only one in the center among the seven glass rods was supported and sintering was performed. While two of the three porous preforms were able to be sintered, cracks were formed on the upper part of the glass body. In addition, one of the three porous preforms had cracks generated in the porous material during sintering, and one glass rod on the outer peripheral side fell out.

### EXAMPLE 2

As Example 2 of the present invention, three porous preforms were produced according to the method of Embodiment 2 and sintered in accordance with the method of Embodiment 2 to produce three optical fiber preforms. No abnormalities such as cracks were observed in the three optical fiber preforms, and they were favorable.

### EXAMPLE 3

As Example 3 of the present invention, three porous preforms were produced according to the method of Embodiment 4 and sintered in accordance with the method of Embodiment 4 to produce three optical fiber preforms. Although the three optical fiber preforms had cracks on the upper part, no abnormalities such as cracks were observed in most of the other parts, and the three optical fiber preforms were favorable. It should be noted that when the vicinity of the support jig was verified after sintering, the glass rods were inclined between the glass body and the support jig.

### EXAMPLE 4

As Example 4 of the present invention, three porous preforms were produced according to the method of Embodiment 5 and sintered in accordance with the method of Embodiment 5 to produce three optical fiber preforms. Although the three optical fiber preforms had cracks on the upper part, no abnormalities such as cracks were observed in most of the other parts, and the three optical fiber preforms were favorable. It should be noted that when the vicinity of the support jig was verified after sintering, the glass rods were inclined between the glass body and the support jig.

### EXAMPLE 5

As Example 5 of the present invention, three porous preforms were produced according to the method of Embodiment 6 and sintered in accordance with the method of Embodiment 2 to produce three optical fiber preforms.

In particular, a silica particle slurry was produced by adding commercially available gas phase synthetic silica particles having an average primary particle size of 10 μm and pure water as a solvent to polyvinyl alcohol (PVA) as a particle bonding agent. Silica granulated particles having a volume value of 50% and a particle diameter of 100 μm were prepared from the produced silica particle slurry using a spray dryer device.

Next, the silica granulated particles were inserted into a pressurized mold in which three core rods were gripped, and a porous material to serve as a pressure-molded body was obtained using a pressurizing plunger. The pressurizing mold was a division type, and the porous preform was divided and taken out after pressurizing. The obtained porous material was heat-treated in an oxygen atmosphere to oxidize and remove the PVA, and then sintered using the same support jig as in the case of Example 2 to produce three optical fiber preforms. No abnormalities such as cracks were observed in the three optical fiber preforms, and they were favorable.

Further, the present invention is not limited by the embodiments described above. The present invention includes configurations created by appropriately combining each of the above-described constituent elements. Further effects and modifications can be easily derived by those skilled in the art. Accordingly, the broader aspects of the present invention are not limited to the above embodiments, and various modifications are possible.

### INDUSTRIAL APPLICABILITY

As described above, the present invention is suitable for application to the manufacturing of, for example, optical fiber.

### REFERENCE SIGNS LIST

1, 1a, 1b, 1A Core portion
2, 2A Cladding portion
3, 3A Multi core fiber
4 Porous preform
5, 5a, 5b, 5A, 5C Glass rod
5Aa, 5Ca, 42Aba, 42Aca Recessed portion
5Aaa, 5Caa Bottom surface
5Aab, 5Cab, 5Cac Inner side surface
5c, 42ba, 44Ba Through-hole
10, 10A Support jig
11, 11A Rotational axis shaft
12, 12a, 12b, 12A Glass rod support pipe
12c, 12e, 12Ac Rod-fixing screw hole
12d Rod hole position adjustment hole
13 Connecting rod
13A Connecting plate
14 Fixing screw
20 OVD device
21 Chuck
22 Main burner
23 End burner
24 Exhaust hood
25 Exhaust pipe
30, 30A, 30B, 30C Porous preform
31, 31A, 31B, 31C Porous material
35A, 35C, 35D Optical fiber preform
36A, 36C, 36D Glass body
40, 40A, 40B, 40C, 40D Support jig
41, 41A, 41B, 41C, 41D Rotational axis shaft
42, 42A, 42B, 42C, 42D Support member
42Aa, 42Ba Long hole
42Ab, 42Ac, 42Ad Member
42Abb, 42Acb Plate portion
42Abc Cylindrical portion
42Abd Connecting portion
42Acd Extending portion
42Ace, 42Ada Stepped portion
42Bb Guide groove
42Ca, 42Da Notch
42a Base portion
42b Support portion
43, 43A, 43B, 43D Connecting rod
44, 45B Fixing pin
44B Fixing ring
50 Pressurizing mold
51 Granulated particles
52 Pressurizing plunger

1: A manufacturing method for an optical fiber preform, the method comprising:
forming a porous material made of fine silica glass particles surrounding a plurality of glass rods; and
sintering the porous material,
wherein
the forming the porous material includes forming the porous material such that two or more of the plurality of glass rods protrude from the porous material, and
the sintering includes supporting end portions of protruding sides of the two or more protruding glass rods collectively with a support jig, and performing the sintering.

2: The manufacturing method for the optical fiber preform according to claim 1, wherein
the support jig is configured to allow the supported glass rods to move in a direction that approaches the center axis of the porous material.

3: The manufacturing method for the optical fiber preform according to claim 1, wherein
the support jig is configured to allow the supported glass rods to be tilted in a direction that approaches the center axis of the porous material.

4: A manufacturing method for optical fiber, the method comprising drawing an optical fiber from an optical fiber preform manufactured by the manufacturing method according to claim 1.
